(19) United States
(12) Patent Application Publication
(10) Pub. No.: US 2011/0273060 A1
(43) Pub. Date: Nov. 10, 2011

(54) Hybrid piezoelectric generation

(76) Inventor: Yao-Tung Chen, Taipei County (TW)

(21) Appl. No.: 12/662,875

(22) Filed: May 10, 2010

(51) Int. Cl. H02N 2/18

(52) U.S. Cl. 310/339

(57) ABSTRACT

A piezoelectric generator has a central shaft for rotating a rotating unit in a carrier. At this time, projections and actuating rods of the rotating unit intermittently contact with balls of a first piezoelectric unit and a second piezoelectric unit and second piezoelectric transducers of the carrier.

Meanwhile, the higher piezoelectric effect may be generated through the serial connection of the same central shaft.

### BACKGROUND OF THE INVENTION

(1) Field of the Invention

The invention relates to a piezoelectric generator, and more particularly to a hybrid piezoelectric generator.

(2) Description of the Prior Art

According to the piezoelectric principle, stresses are applied to cause deformation so that the piezoelectric transducer unit can generate the maximum electrical energy output under the action of the constant external force. The piezoelectric material has the particular relationship between the deformation (or strain) and the voltage, and can generate the maximum deformation under the same driving voltage, and can generate the maximum voltage output under the same deformation. At this time, the piezoelectric material has the highest electromechanical energy conversion effect. A mechanical structure has to be provided so that the piezoelectric material can withstand the stress and another mechanical structure is also needed to stabilize the mechanical energy input. Thus, if the two mechanical structures satisfying two different requirements of pre-applying stresses and stabilizing the mechanical energy input can be integrated, it is advantageous to the manufacturing of a piezoelectric generator module with the high conversion efficiency.

Bouncing forces of balls may be adopted so that the stresses may be pre-applied to the piezoelectric material. Under the action of the externally applied forces, the buffer properties of the balls make the piezoelectric material have the longer time of outputting the voltage so that it is advantageous to the capturing and storage of the electrical energy. The basic structure of the conventional piezoelectric generator is a piezoelectric transducer unit working in conjunction with a mechanical structure. The mechanical structure changes the direction of the external force and lengthens the action time so that the external force can cause the deformation in the piezoelectric transducer unit, and the electrical energy may be outputted through the electromechanical conversion transition property and the circuit wiring. In order to increase the converted energy, the mechanical structure is often designed to have the high sensitivity so that the change may be quickly transferred to the piezoelectric transducer unit with the action of the external force. In addition, the greater electrical energy output may be provided by connecting many piezoelectric units together.

Therefore, it is an important direction to enhance the performance in the industry.

### SUMMARY OF THE INVENTION

In view of the background of the invention and in order to satisfy some beneficial requirements in the industry, the invention provides a piezoelectric generator for achieving the object which cannot be achieved by the conventional piezoelectric unit.

An object of the invention is to provide .a hybrid piezoelectric generator including two piezoelectric units and one wheel so that a vertical axial direction may be defined to enhance the piezoelectric conversion effect.

Another object of the invention is to provide a hybrid piezoelectric generator having a central shaft for connecting a plurality of piezoelectric units in series to obtain the higher piezoelectric conversion effect.

The invention provides a piezoelectric generator including a carrier, a wheel, a first piezoelectric unit, a first cover, a second piezoelectric unit and a second cover. The carrier is a hollow cylinder and has an inner surface having a plurality of second piezoelectric transducers. The wheel is disposed in a hollow central portion of the carrier. The wheel has a first surface and a second surface disposed opposite the first surface, each of the first and second surfaces has a plurality of projections, and a side surface of the wheel has a plurality of actuating rods. The first piezoelectric unit has a plurality of balls and a plurality of first piezoelectric transducers. The balls have exposed contact surfaces respectively corresponding to and contacting with the plurality of projections on the first surface of the wheel. The balls are connected to a first base through the first piezoelectric transducers. The first cover has a surface connected to unexposed surfaces of the balls of the first piezoelectric unit, wherein a periphery of the first cover is fastened to the carrier. The second piezoelectric unit has a plurality of the balls having exposed contact surfaces respectively corresponding to and contacting with the plurality of projections on the second surface of the wheel. The balls are connected to a second base through the first piezoelectric transducers. The second cover has one surface connected to unexposed surfaces of the balls of the second piezoelectric unit, wherein a periphery of the second cover is fastened to the carrier.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing a hybrid piezoelectric generator according to the invention.

FIG. 2 is a schematically cross-sectional view showing the hybrid piezoelectric generator of the invention.

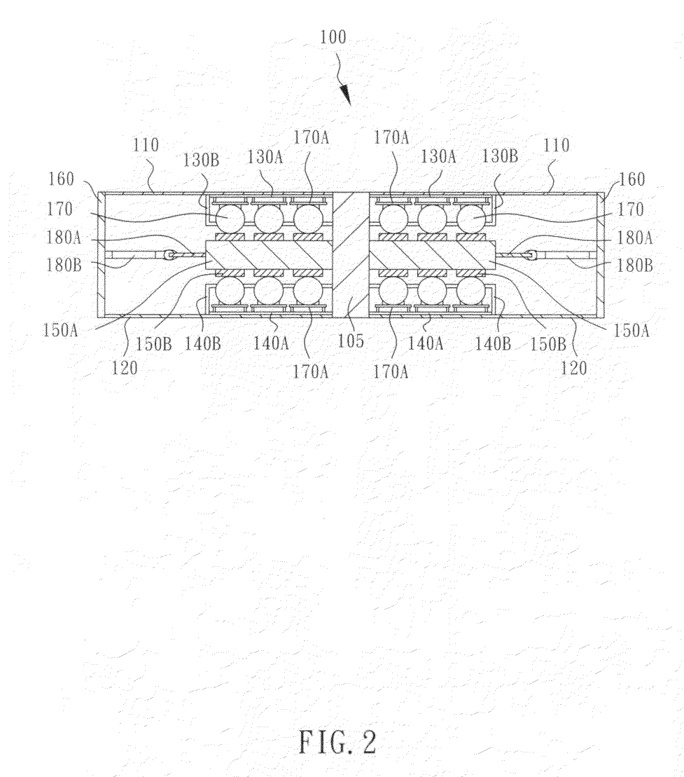

FIG. 3 is a schematic illustration showing the serial connection of the hybrid piezoelectric generator of the invention.

### DETAILED DESCRIPTION OF THE PREFERRED EMBODIMENTS

The invention is directed to a piezoelectric generator. In order to make the invention be clearly and completely understood, detailed structures and elements thereof will be described in the following. Obviously, the implementation of the invention is not restricted to the specific details known by those skilled in the art of the piezoelectric generator. On the other hand, the well-known structures and the associated elements are not described in the details to prevent the unessential limitations to the invention. The preferred embodiment of the invention will be described in detailed in the following. In addition to these details, however, the invention may also be widely implemented in other embodiments, and the scope of the invention is not particularly restricted and will be based on the following claims.

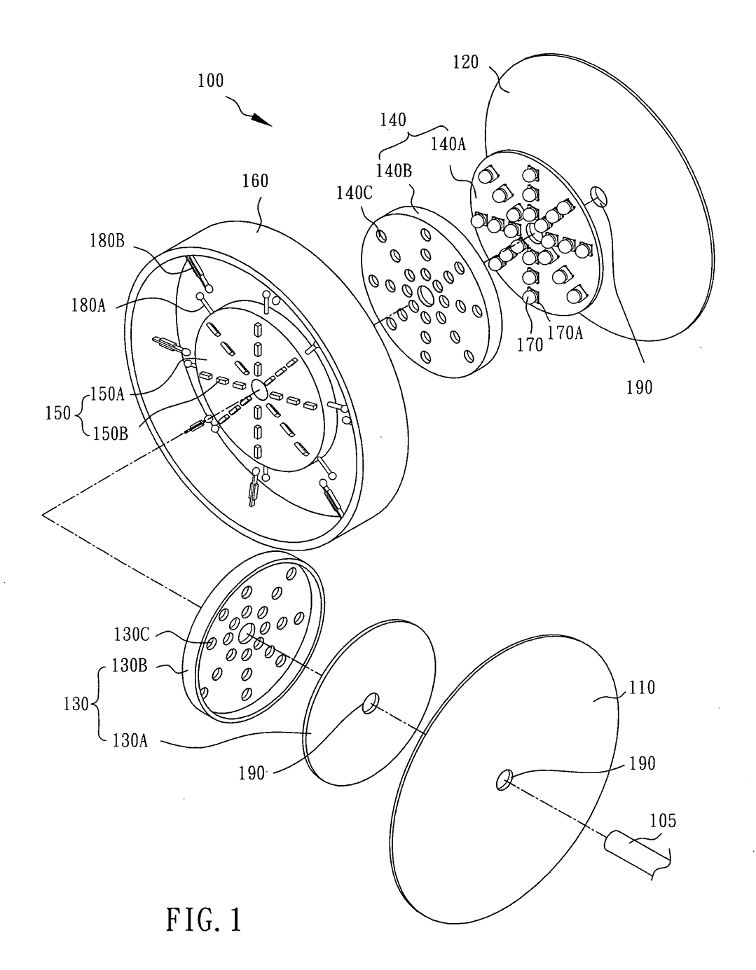

Referring to FIG. 1, the invention provides a piezoelectric generator 100 according to a preferred embodiment of the invention. The piezoelectric generator 100 includes a first cover 110, a second cover 120, a first piezoelectric unit 130, a second piezoelectric unit 140, a rotating unit 150 and a carrier 160, each of which has a hole 190 on a center of a surface thereof so that a central shaft 105 can pass through all the elements and connect all the elements in series.

The first piezoelectric unit 130 has a first base 130A and a first piezoelectric element cover 130B. The second piezoelectric unit 140 has a second base 140A and a second piezoelectric element cover 140B. Each of the first base 130A and the second base 140A has balls 170 disposed on a surface thereof. In addition, the first piezoelectric element cover 130B and the second piezoelectric element cover 140B respectively have a plurality of first through holes 130C and a plurality of second through holes 140C for exposing contact surfaces of the balls 170. The ball 170 may have a spherical shape or a spring shape. In addition, the balls 170 are respectively connected to the first base 130A and the second base 140A through a plurality of first piezoelectric transducers 170A, and each of the first piezoelectric transducers 170A is made of an elastic material.

Referring to FIG. 1, the rotating unit 150 has a wheel 150A and a plurality of actuating rods 180A formed on a sidewall surface of the wheel 150A. The wheel 150A has a first surface and a second surface disposed opposite the first surface. Projections 150B are formed on the first and second surfaces of the wheel 150A. The number and positions of the projections 150B respectively correspond to the number and positions of the balls 170. In addition, the carrier 160 is a hollow cylinder for accommodating all elements therein, and the inner surface of the carrier 160 has a plurality of second piezoelectric transducers 180B. The number and positions of the second piezoelectric transducers 180B respectively correspond to the number and positions of the actuating rods 180A. Each of the second piezoelectric transducers 180B is made of an elastic material.

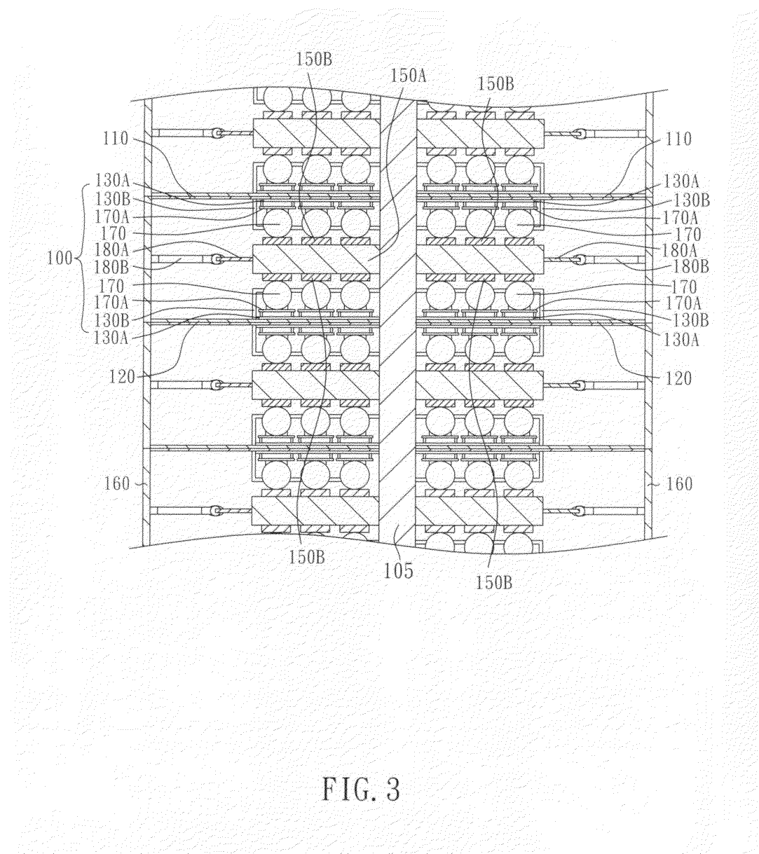

As shown in FIG. 1, the central shaft 105 passes through all the elements so that all the elements are connected in series and packaged in the carrier 160. The relative positions will be described in the following. The rotating unit 150 is disposed in a hollow central portion of the carrier 160. The exposed contact surfaces of the balls 170, exposed out of the first piezoelectric element cover 130B of the first piezoelectric unit 130 and the second piezoelectric element cover 140B of the second piezoelectric unit 140, correspond to and contact with the projections 150B formed on the opposite first and second surfaces of the rotating unit 150. The other surfaces of the first base 130A of the first piezoelectric unit 130 and the second base 140A of the second piezoelectric unit 140 are respectively connected to the first cover 110 and the second cover 120. The peripheries of the first cover 110 and the second cover 120 are fastened to the carrier. Thus, when the central shaft 105 rotates, the central shaft 105 rotates the rotating unit 150 in the carrier 160. At this time, the actuating rods 180A intermittently contact with the second piezoelectric transducers 1808 of the carrier 160 as the rotating unit 150 is rotated. In addition, the piezoelectric generator 100 may also generate the higher piezoelectric effect through the serial connection of the same central shaft, as shown in FIG. 3.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A piezoelectric generator, comprising:
a carrier, which is a hollow cylinder and has an inner surface having a plurality of second piezoelectric transducers;
a wheel disposed in a hollow central portion of the carrier, wherein the wheel has a first surface and a second surface disposed opposite the first surface, each of the first and second surfaces has a plurality of projections, and a side surface of the wheel has a plurality of actuating rods;
a first piezoelectric unit having a plurality of balls having exposed contact surfaces respectively corresponding to and contacting with the projections on the first surface of the wheel;
a first cover having a surface connected to unexposed surfaces of the balls of the first piezoelectric unit, wherein a periphery of the first cover is fastened to the carrier;
a second piezoelectric unit having a plurality of balls having exposed contact surfaces respectively corresponding to and contacting with the projections on the second surface of the wheel; and
a second cover having a surface connected to unexposed surfaces of the balls of the second piezoelectric unit, wherein a periphery of the second cover is fastened to the carrier.

2. The piezoelectric generator according to claim 1, further comprising a central shaft for connecting a plurality of the piezoelectric generators in series.

3. The piezoelectric generator according to claim 1, wherein the projections of the first surface of the wheel correspond to and contact with the balls of the first piezoelectric unit.

4. The piezoelectric generator according to claim 1, wherein the projections of the second surface of the wheel correspond to and contact with the balls of the second piezoelectric unit.

5. The piezoelectric generator according to claim 1, wherein the first piezoelectric unit further comprises a first base and a first piezoelectric element cover, the balls are formed on a surface of the first base, the first piezoelectric element cover has a plurality of first through holes for exposing the contact surfaces of the balls, the other surface of the first base is connected to the surface of the first cover, and the balls are connected to the first base through a plurality of first piezoelectric transducers.

6. The piezoelectric generator according to claim 1, wherein the second piezoelectric unit further comprises a second base and a second piezoelectric element cover, the balls are formed on a surface of the second base, the second piezoelectric element cover has a plurality of second through holes for exposing the contact surfaces of the balls, the other surface of the second base is connected to the surface of the second cover, and the balls are connected to the second base through a plurality of first piezoelectric transducers.

7. The piezoelectric generator according to claim 1, wherein each of the balls has a spherical shape or a spring shape.

8. The piezoelectric generator according to claim 1, wherein the number and positions of the second piezoelectric transducers respectively correspond to the number and positions of the actuating rods.

9. The piezoelectric generator according to claim 1, wherein each of the first piezoelectric transducers and the second piezoelectric transducers is made of an elastic material.
